(19) United States
(12) Patent Application Publication
(10) Pub. No.: US 2017/0313375 A1
(43) Pub. Date: Nov. 2, 2017

(54) TILTING-CAPABLE THREE-WHEELED BOARDING VEHICLE

(71) Applicant: Jong-ho LEE, Sacheon-si (KR)

(72) Inventor: Jong-ho LEE, Sacheon-si (KR)

(21) Appl. No.: 15/529,753

(22) PCT Filed: May 19, 2015
(86) PCT No.: PCT/KR2015/004997

§ 371 Date: May 25, 2017

(30) Foreign Application Priority Data
Dec. 31, 2014 (KR) 10-2014-0196114
May 8, 2015 (KR) 10-2015-0064281

(51) Int. Cl. B62K 5/10; B62M 1/28; B62K 5/02

(52) U.S. Cl. CPC B62K 5/10; B62K 5/02; B62M 1/28

(57) ABSTRACT

The present disclosure provides a tilting-capable three-wheeled boarding vehicle comprising: a steering-assembly configured to enable steering and tilting of the vehicle; a tilting-capable assembly including one driving wheel and a rotatable elongate body extending from the steering-assembly toward driven-wheels; a non-tilted assembly including a non-rotatable elongate body, the two driven wheels, a shaft connecting the two driven wheels to each other, and a first support bar extending perpendicularly to the non-rotatable elongate body, wherein the rotatable elongate body is rotatably coupled to the non-rotatable elongate body; and a vertically-movable elongate assembly pivotally coupled, at one end thereof, to the rotatable elongate body and contacting, at the other end thereof, the first support bar during downward movement thereof, wherein the vertically-movable elongate assembly is configured to vertically move by pedaling forces from a user.

### CROSS-REFERENCE TO RELATED APPLICATION

This application claims the benefit of Korean patent application No. 10-2014-0196114 filed on Dec. 31, 2014, and Korean patent application No. 10-2015-0064281 filed on May 8, 2015, the entire content of which are incorporated herein by reference for all purposes as if fully set forth herein.

### BACKGROUND

### Field of the Present Disclosure

The present disclosure relates to a tilting-capable three-wheeled boarding vehicle. More particularly, the preset disclosure relates to a tilting-capable three-wheeled boarding vehicle that allows a user to step on a pedal portion in his/her standing state to drive a driving wheel, and to allow a certain portion to be tilted during corner driving.

### Discussion of Related Art

In general, a boarding vehicle refers to a vehicle for moving a passenger or moving or carrying various articles, and may include a bicycle, a board, a scooter, and the like. Such a boarding vehicle is configured to have a driving wheel, follower wheels, and a boarding area, and may be classified into a three-wheel type or a reverse three-wheel type.

A three-wheel type or a reverse three-wheel type boarding vehicle tends to go outwardly due to the centrifugal force when traveling at a corner or a bent road at high speed. In order to offset this centrifugal force, tilting is required to tilt the boarding vehicle inwardly. Therefore, much research has been conducted on the tilting of such a boarding vehicle.

However, in a three-wheeled boarding vehicle on which the user stands up, when the foot is released from one pedal, the occupant presses the other pedal such that the body of the boarding vehicle tilts toward the other pedal. In this case, the tilting action of the boarding vehicle may be counteracted to some extent by the user holding the horizontal handle. However, when the pedal is continuously depressed, the vehicle tilts to the left and right as if it is dancing.

The prior art relating to the present disclosure is disclosed in Korean Patent No. 10-1008391 (patented on Jan. 17, 2011).

### SUMMARY

It is an object of the present disclosure to provide a tilting-capable three-wheeled vehicle which prevents the boarding vehicle from tilting even when the weight of the occupant moves to one side when the pedal is depressed.

Another object of the present disclosure is to provide a tilting-capable three-wheeled boarding vehicle capable of traveling in a stable posture without being tilted to one side even when the pedals are stepped on both feet. It is another object of the present disclosure to provide a tilting-capable three-wheeled boarding vehicle capable of tilting a tilting body in response to a tilting operation of a steering wheel when cornering.

The purposes to be achieved by the present disclosure are not limited to these, and other technical purposes not mentioned will be clearly understood by those skilled in the art from the following description.

In one aspect, there is provided a tilting-capable three-wheeled boarding vehicle comprising: a steering-assembly configured to enable steering and tilting of the vehicle; a tilting-capable assembly including one driving-wheel located below the steering-assembly, and a rotatable elongate body extending from the steering-assembly toward driven-wheels; a non-tilted assembly including a non-rotatable elongate body, the two driven wheels, a shaft connecting the two driven wheels to each other, and a first support bar extending perpendicularly to the non-rotatable elongate body, wherein the rotatable elongate body is rotatably coupled to the non-rotatable elongate body, wherein the first support bar and the shaft are arranged in parallel spaced apart from each other; a vertically-movable elongate assembly pivotally coupled, at one end thereof, to the rotatable elongate body and contacting, at the other end thereof, the first support bar during downward movement thereof, wherein the vertically-movable elongate assembly is configured to vertically move by pedaling forces from a user; and, a power-transmission operatively coupled to the vertically-movable elongate assembly and configured to transmit the pedaling forces from the vertically-movable elongate assembly to the driving-wheel, wherein when the steering assembly is tilted to one side, the non-tilted assembly is configured not to be tilted, but the tilting-capable assembly and the vertically-movable elongate assembly are configured to be together tilted to said one side.

In one embodiment, the tilting-capable assembly further comprises a second support bar, wherein the second support bar extends perpendicularly to the rotatable elongate body and is disposed on the rotatable elongate body and is spaced apart from and parallel to the first support bar, wherein the second support bar is configured to be tilted to said one side together with the steering assembly, the tilting-capable assembly, and the vertically-movable elongate assembly.

### Effects of the Present Disclosure

According to the tilting-capable three-wheeled boarding vehicle according to the present disclosure, the boarding vehicle is not tilted when the weight of the occupant is biased to one side, such as, when the vertically-movable elongate bar is stepped on by the rider.

Further, according to the tilting-capable three-wheeled boarding vehicle according to the present disclosure, even when the vertically-movable elongate bars are stepped on both feet, the vehicle is not tilted to either side, and thus can travel in a stable posture. Further, when the vehicle runs on the corner, the tilting-capable assembly tilts according to the tilting operation of the steering-assembly, thereby enabling safe cornering.

The effects of the present disclosure are not limited to the effects mentioned above, and other effects not mentioned can be clearly understood by those skilled in the art from the claims.

### BRIEF DESCRIPTIONS OF DRAWINGS

FIG. 1 is a perspective view schematically illustrating a tilting-capable three-wheeled boarding vehicle according to a preferred embodiment of the present disclosure.

FIG. 2 is a side elevation view schematically illustrating a tilting-capable three-wheeled boarding vehicle according to a preferred embodiment of the present disclosure.

FIG. 3 is a top view schematically illustrating a tilting-capable assembly, a non-tilted assembly, and a vertically-movable elongate assembly in FIG. 1.

FIG. 4 is an enlarged perspective view of an A portion in FIG. 3.

FIG. 5 is a diagram illustrating the position of left and right pedals in a simplified manner using multiple lines.

FIGS. 6 and 7 are schematic views for illustrating a tilting operation of a tilting-capable assembly and a vertically-movable elongate assembly with connection to a first support bar and a second support bar, according to an embodiment of the present disclosure.

### REFERENCE NUMERALS

10: tilting-capable three-wheeled boarding vehicle

100: steering-assembly 110: horizontal handle

120: vertical extension 200: tilting-capable assembly

210: driving-wheel 220: rotation-shaft

230: vertical fork 240: rotatable elongate body

250: second support bar 300: non-tilted assembly

310: non-rotatable elongate body 320: driven-wheel shaft

330: driven-wheels 340: first support bar

350: rotatable tube 360: tilting-suppression members

400: vertically-movable elongate assembly 411: left vertically-movable elongate bar

412: right vertically-movable elongate bar 421: left pedal

422: right pedal 500: power-transmission

### DETAILED DESCRIPTIONS

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items.

As used herein, a tilting-capable three-wheeled boarding vehicle may refer to a three-wheeled vehicle or a three-wheeled board. Hereinafter, the three-wheeled board will be exemplified as the tilting-capable three-wheeled boarding vehicle. However, the present disclosure is not limited to this.

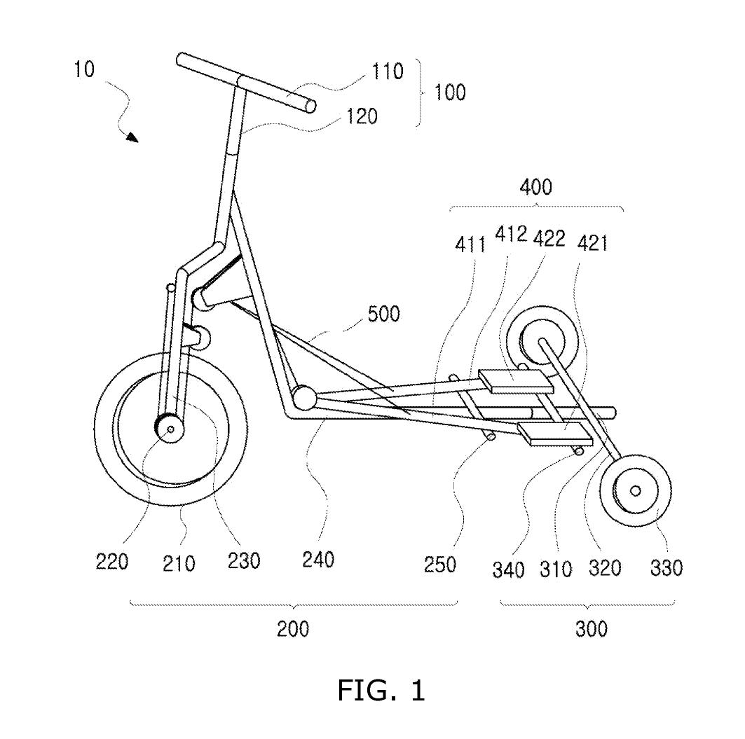

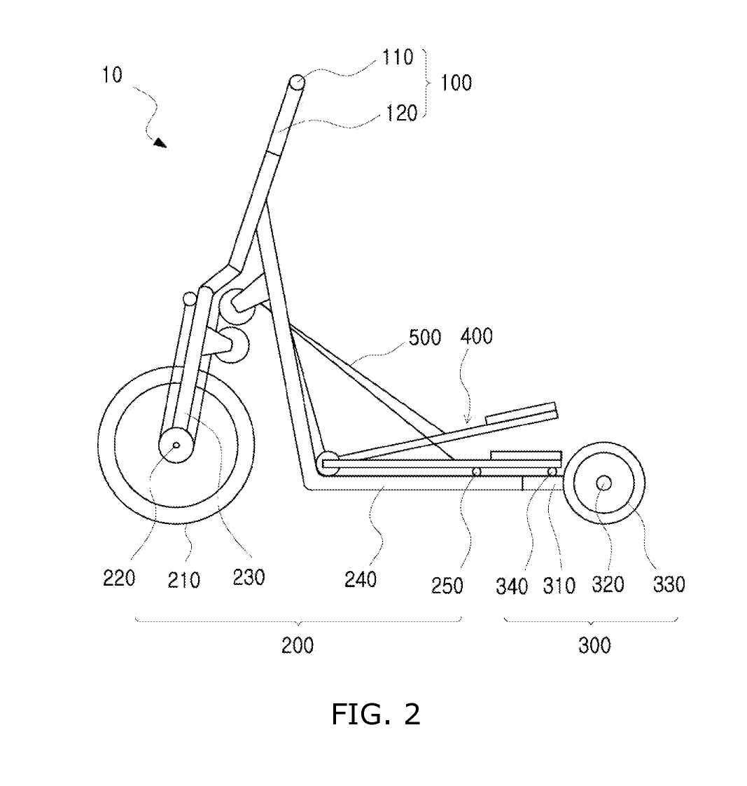

Referring to FIG. 1 to FIG. 4, a tilting-capable three-wheeled boarding vehicle 10 includes a steering assembly 100, a tilting-capable assembly 200, a non-tilted assembly 300, a vertically-movable elongate assembly 400, and a power-transmission 500.

The steering-assembly 100 may include a horizontal handle 110 and a vertical extension 120.

The horizontal handle 110 may be provided in the shape of a bar and be gripped by the user or the passenger's hand. The vertical extension 120 extends downward from the horizontal handle 110 and may be coupled to the tilting-capable assembly 200. The vertical extension 120 may be formed of a metal pipe or the like.

The steering-assembly 100 may be configured to enable steering and tilting of the boarding vehicle 10.

The tilting-capable assembly 200 may include a driving-wheel 210, a rotation-shaft 220, a vertical fork 230, and a rotatable elongate body 240. The tilting-capable assembly 200 may be provided below the steering-assembly 100.

A single driving-wheels 210 may be provided. The driving-wheel 210 is rotatably coupled to the rotation shaft 220 installed on the vertical fork 230.

When the size of the driving-wheel 210 is small, there is a risk of overturning of the vehicle due to a small stump or depression on the road surface, and the horizontal handle 110 is likely to turn around. Therefore, safety may be deteriorated. Accordingly, it is preferable that the size of the driving-wheel 210 is appropriately large.

The vertical fork 230 may be fixedly coupled to the lower end of the vertical extension 120.

The rotatable elongate body 240 may extend from the steering-assembly 100 toward the later-described driven-wheels 330. In other words, the rotatable elongate body 240 may provide a user or passenger boarding area behind the vertical fork 230. The rotatable elongate body 240 may be coupled to the lower end of the vertical extension 120 and extend rearward. That is, the front end of the rotatable elongate body 240 is coupled to the lower end of the vertical extension 120, and the rear end of the rotatable elongate body 240 is rotatably inserted into a non-rotatable elongate body 310 described later. Thus, when the steering-assembly 100 is tilted to one side, the steering-assembly 100, the driving-wheel 210 and the rotatable elongate body 240 are configured to tilt together to said one side.

The rotatable elongate body 240 may be provided in an approximately L shape or the like.

The non-tilted assembly 300 may include the non-rotatable elongate body 310, the driven-wheel shaft 320, the driven-wheels 330, and the first support bar 340.

The non-rotatable elongate body 310 may be coupled to an end (rear end) of the rotatable elongate body 240. Accordingly, an end (rear end) of the rotatable elongate body 240 may be rotatably inserted and coupled to the front end of the non-rotatable elongate body 310.

The driven-wheel shaft 320 may be fixedly coupled to the non-rotatable elongate body 310 at a rear end thereof in a direction perpendicular to the non-rotatable elongate body 310, as viewed from above. The driven-wheel shaft 320 is preferably provided with a sufficient length to improve safety.

The driven-wheels 330 may be rotatably coupled to both ends of the driven-wheel shaft 320 respectively. That is, two driven-wheels 330 may be provided.

Thus, since the non-tilted assembly 300 may be supported at the two driven-wheels 330 and at a combination point of the rotatable elongate body 240 and the non-rotatable elongate body 310, that is, at the three points, the assembly 300 does not tilt sideway.

The first support bar 340 may be provided at a predetermined position on the non-rotatable elongate body 310. The first support bar 340 may be fixedly coupled to one end (front end) of the non-rotatable elongate body 310 and may extend in parallel to the driven-wheel shaft 320. On the first support bar 340, the vertically-movable elongate assembly 400 moving downward may be placed.

The vertically-movable elongate assembly 400 may be provided symmetrically. One end (front end) of the vertically-movable elongate assembly 400 is pivotally coupled to the rotatable elongate body 240 and the other end (rear end) of the vertically-movable elongate assembly 400 is configured to be vertically movable. The other end (rear end) of the vertically-movable elongate assembly 400 may be placed on the first support bar 340 during downward movement. The vertically-movable elongate assembly 400 is coupled to a power-transmission 500 coupled to the driving-wheel 210. The power-transmission 500 may provide driving or driving force to the driving-wheel 210.

The vertically-movable elongate assembly 400 may include the left and right vertically-movable elongate bars 411 and 412 and the left and right pedals 421 and 422. That is, the vertically-movable elongate bars 411, 412 and the pedals 421, 422 may be configured so that the user or passenger may step the pedals 421, 42 on the left and right foot alternately respectively.

One end (front end) of the left vertically-movable elongate bar 411 may be coupled to the body 240 so as to be movable up and down at the left side of the rotatable elongate body 240 when viewed from the rear. One end (front end) of the right vertically-movable elongate bar 412 may be coupled to the body 240 so as to be movable up and down at the right side of the rotatable elongate body 240 when viewed from the rear. That is, each of the left and right vertically-movable elongate bars 411 and 412 may pivotally move around one end (front end) of each of the left and right vertically-movable elongate bars 411 and 412 coupled to the rotatable elongate body 240. The front ends of the left and right vertically-movable elongate bars 411 and 412 are preferably joined at the center portion of the rotatable elongate body 240 when viewed from the left and right.

For example, the left and right vertically-movable elongate bars 411 and 412 may be pivotally coupled, at the ends (front ends), thereof, to the left and rear sides of the front end central portion of the rotatable elongate body 240 using pins respectively. Further, the left and right vertically-movable elongate bars 411 and 412 may extend so that the distance between the elongate bars 411 and 412 gradually increases toward the rear end side.

The left and right pedals 421 and 422 may be provided on the other ends (rear ends) of the left vertically-movable elongate bar 411 and the right vertically-movable elongate bar 412, respectively. These pedals 421, 422 allow the user or occupant's feet to rest on the vertically-movable elongate bars 411, 412 respectively.

The left and right vertically-movable elongate bars 411, 412 and the pedals 421, 422 may be configured to be able to be depressed by the user's feet. Such a depressing operation may generate a driving force provided to the driving-wheel 210. In this connection, the left and right vertically-movable elongate bars 411 and 412 may be configured separately to enable independent operations thereof with respect to each other.

Further, when the boarding vehicle 10 according to the present disclosure is in a straightly running state or in a stop state, the rear ends of the left and right vertically-movable elongate bars 411 and 412 may be placed or laid on the first support bar 340 upon completion of downward movement thereof.

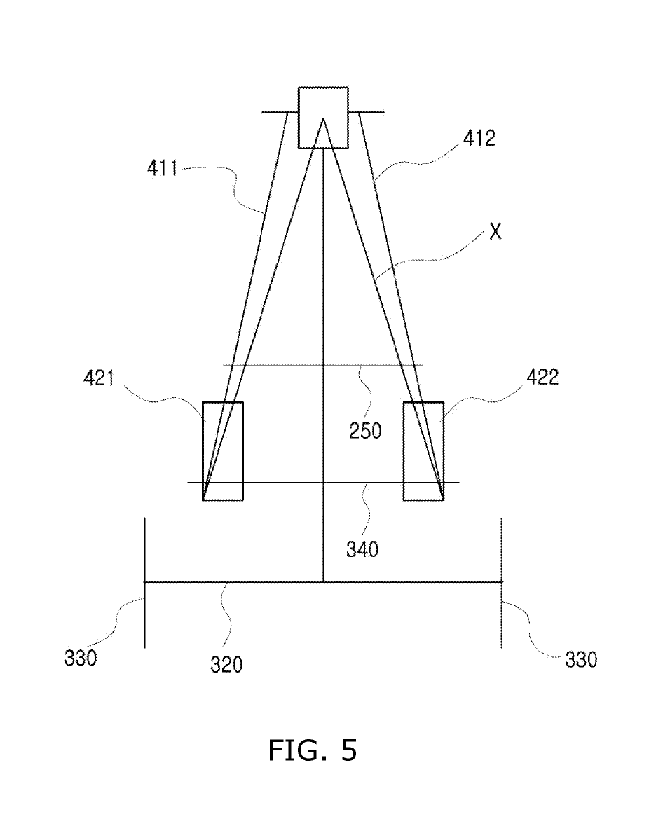

Referring to FIG. 5, the left and right pedals 421 and 422 are preferably located on and extend along left and right imaginary straight lines Xs respectively. The left and right virtual straight lines extends respectively between the rear ends of the left and right vertically-movable elongate bars 411 and 412 placed on the first support bar 340 upon completion of downward movement thereof, and the left and right points from the central point of the front end of the rotatable elongate body 240 to which the front ends of the left and right vertically-movable elongate bars 411 and 412 are coupled respectively. The left and right pedals 421 and 422 may be mounted on the other ends (rear ends) of the left and right vertically-movable elongate bars 411 and 412, respectively.

Thus, when each of the left and right pedals 421 and 422 is positioned on and extends along the imaginary extension straight line X of the vertically-movable elongate bar, the tilting-capable assembly 200 is not tilted even when the weight of the user or the occupant is concentrated on one pedal 421 or 422 of the two pedals. That is, in accordance with the present disclosure, by allowing the force pressing the pedals 421, 422 to act along the imaginary extension straight line X of the vertically-movable elongate bar, the vertically-movable elongate bars 411 may not be subjected to the twisting force.

To the contrary, when each of the left and right pedals 421 and 422 is not positioned on and does not extend along the imaginary extension straight line X of the vertically-movable elongate bar, the tilting-capable assembly 200 is tilted when the weight of the user or the occupant is concentrated on one pedal 421 or 422 of the two pedals. This is because the elongate bar coupled to the force-concentrated pedal is subjected to the twisting force. Further, the vertically-movable elongate bars 411 and 412 may not be tilted back and forth due to the rotatable elongate body 240 and the first support bar 340 supporting the vertically-movable elongate bars 411 and 412.

However, when the weight are increasingly applied onto one vertically-movable elongate bar (411 or 412) at a higher level, the user tilts toward said one of the elongate bars. At this time, the user may hold the horizontal handle 110 by hand and avoid falling. In addition, it is not preferable to put a lot of weight on the vertically-movable elongate bar 411 or 412 at the higher level because it is not good for the knee joints health.

Each of left and right power-transmissions 500 may be configured to transmit the driving force generated by the motion of the vertically-movable elongate assembly 400 to the driving-wheel 210. One ends (rear ends) of the left and right power-transmissions 500 may be connected to predetermined portions of the left and right vertically-movable elongate bars 411 and 412, respectively. According to an example, one ends of the power-transmissions 500 may be connected to longitudinal midpoints of the left and right vertically-movable elongate bars 411 and 412, respectively. The present disclosure is not limited thereto. The other ends (front ends) of the left and right power-transmissions 500 may be power-coupled to the driving-wheel 210.

The power transmissions 500 may be twisted at a position that passes through the center of rotation or the axis of rotation of the vertical fork 230 when the user steering the driving-wheel 210. Thus, the power-transmissions 500 may be made a fiber-rope, whereby the resistance to twisting may be very small.

In the vehicle according to the present disclosure, when the steering-assembly 100 is tilted to either the left or the right side, the tilting-capable assembly 200 and the vertically-movable elongate assembly 400 together are tilted to the same said one side. However, at this time, the non-tilted assembly can maintain its posture without being tilted.

That is, when the boarding vehicle 10 according to the present disclosure is traveling in a corner, and the driver holds the steering-assembly 100 and tilts it inwardly the corner, the tilting-capable assembly 200 and the vertically-movable elongate assembly 400 may be inclined toward the inclined side of the steering-assembly 100. However, the non-tilted assembly 300 may remain un-tilted. That is, the non-tilted assembly 300 is not tilted.

Further, in the vehicle according to the present disclosure, when the tilting-capable assembly 200 and the vertically-movable elongate assembly 400 are tilted to one side by the tilting operation of the steering assembly 100 of the occupant or the user, the rear end of the vertically-movable elongate assembly 400 on the inclined side is held on the first support bar 340. At the same time, the rear end of the vertically-movable elongate assembly 400 on the opposite side may be held in contact with the first support bar 340 due to the weight of the occupant.

Specifically, in the vehicle of the present disclosure, one ends (front ends) of the vertically-movable elongate bars 411 and 412 are coupled to the rotatable elongate body 240, and the rear ends of the vertically-movable elongate bars 411 and 412 are in contact with or supported by the first support bar 340. Accordingly, when the tilting-capable assembly 200 and the vertically-movable elongate assembly 400 are tilted to one side, the vertically-movable elongate bar 411 or 412 on the tilted side is placed on the first support bar 340. Thus, the vertically-movable elongate bar 411 or 412 on the tilted side may not go down any further and remains on the first support bar 340.

On the other hand, the vertically-movable elongate bar 412 or 411 on the opposite side may be raised up by a certain height without touching the first support bar 340. However, the occupant can depress the vertically-movable elongate bar 412 or 411 on the opposite side via his/her body weight, whereby the vertically-movable elongate bar 412 or 411 on the opposite side may be held in a rested state on the first support bar 340.

According to the present disclosure, in a state where the steering-assembly 100, the tilting-capable assembly 200 and the vertically-movable elongate assembly 400 are tilted, when the user brings the steering-assembly 100 to the non-tilted balanced state, the tilting-capable assembly 200 and the vertically-movable elongate assembly 400 return to a non-tilted balanced state.

In addition, when the tilting-capable three-wheeled boarding vehicle 10 according to the present disclosure travels straight ahead or stops, and the occupant's weight is concentrated on one side of the pair of the vertically-movable elongate assemblies 400, the steering-assembly 100 and the tilting-capable assembly 200 are not tilted.

When riding a conventional bicycle, the pedaling force is much less than half of the occupant's weight. Therefore, when the pedal is depressed, the body of the bicycle is not tilted to the left or right.

However, in a conventional board or bicycle on which the user is standing upright, when the user depresses the pedal, the board or bicycle body tilts to the left or right due to the weight shift. Thus, the user must balance it. In other words, the existing stand-up type three-wheel moving vehicle (board, etc.) must be balanced by the user when driving without pedaling or stopping for a while.

However, according to the present disclosure, the vehicle is not tilted to one side, so that even when the user steps on the pedal, the user does not need to balance the vehicle. Thus, it is easy to operate. Particularly, according to the present disclosure, the user does not have to balance the vehicle when the vehicle stops.

For example, according to the present disclosure, a user can promote a product by giving a publicity flyer to a person while driving the vehicle in the city because the user should not balance the vehicle. In addition, in places such as sightseeing spots, the user may enjoy sightseeing while boarding the vehicle in a comfortable manner because the user should not balance the vehicle.

In the conventional moving vehicle, when the user travels along a downhill path, or when the pedal is stopped for a while after pressing the pedal forcedly, the user must balance the vehicle. It is safer not to need to be balanced by the user when driving downhill. In addition, in the conventional moving vehicle, when a pedal rises or when a pedal is lowered during an operation of depressing the pedal, a force tending to tilt the vehicle is generated.

However, according to the present disclosure, only when the pedal is depressed, a force to tilt is applied. There is no force to tilt the vehicle when the pedal is lifted up. Therefore, according to the present disclosure, a second support bar 250 may be further provided to suppress the force to tilt the vehicle when the vertically-movable elongate bar is stepped on. A detailed description thereof will be described later.

Moreover, according to an embodiment of the present disclosure, the non-tilted assembly 300 may further include a rotatable tube 350 and tilting-suppression members 360.

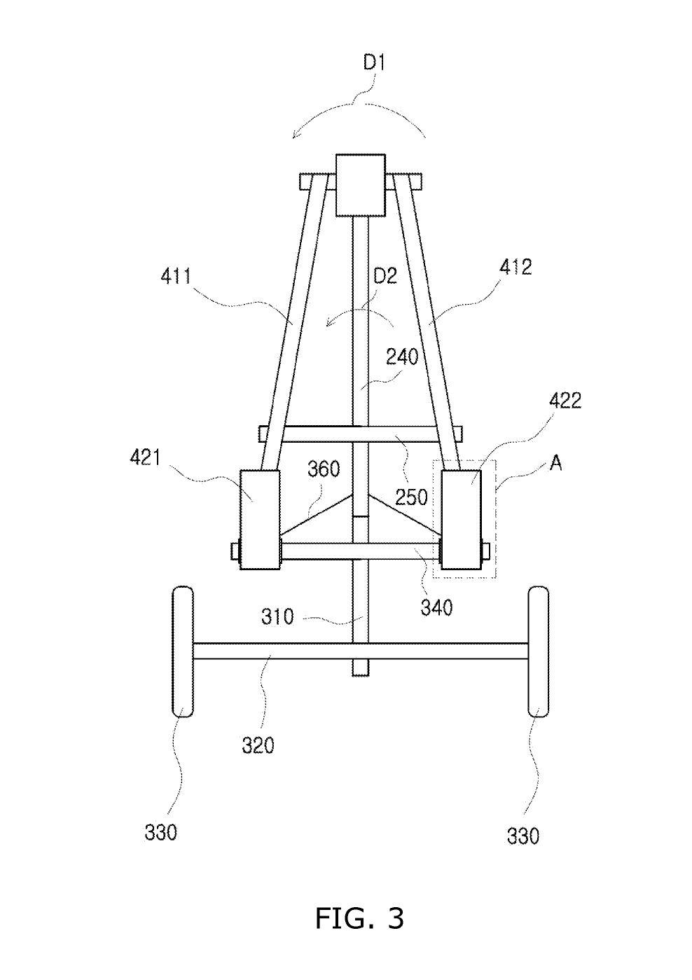

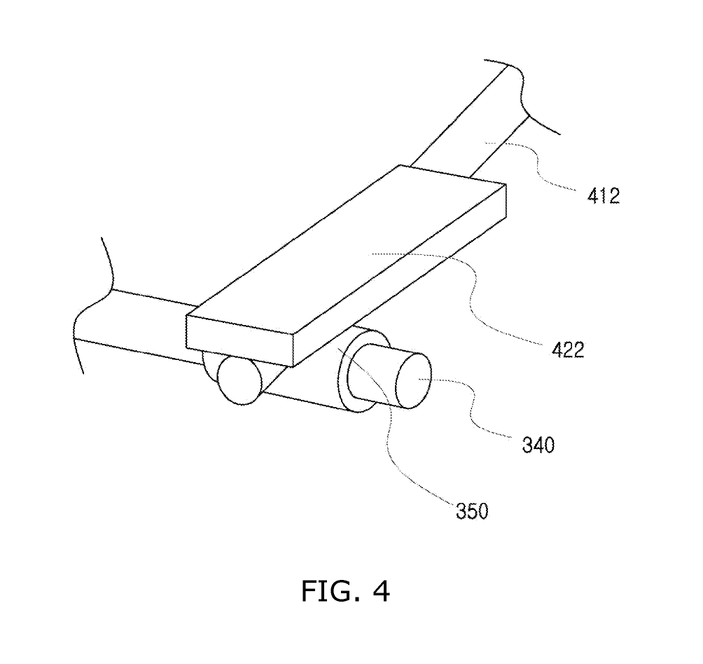

Referring to FIG. 3 and FIG. 4, the rotatable tube 350 may be provided on the first support bar 340 on which the other end (rear end) of the vertically-movable elongate assembly 400 is placed. The rotatable tube 350 may facilitate back and forth movement of the other end (rear end) of the vertically-movable elongate assembly 400 during the tilting-capable assembly 200 is tilted.

In other words, during the steering-assembly 100, the tilting-capable assembly 200 and the vertically-movable elongate assembly 400 are tilted, the rear end of the vertically-movable elongate assembly 400 may be moved back and forth. To facilitate this movement, the rotatable tube 350 may be provided on the first support bar 340 where the other end of the vertically-movable elongate assembly 400 rests. The rotatable tube 350 may be structured to surround the first support bar 340. The tube rotates to facilitate the vertically-movable elongate assembly 400 to be easily moved back and forth.

Referring to FIG. 3, each of the tilting-suppression members 360 may extend from the other end (rear end) of the rotatable elongate body 240 to each of both ends of the first support bar 340. That is, one end of each of the tilting-suppression members 360 may be fixed to the rotatable elongate body 240 and the other end thereof may be fixedly coupled to the first support bar 340. That is, each of the tilting-suppression members 360 may be positioned adjacent to or at a position where the rotatable elongate body 240 is inserted into the non-rotatable elongate body 310.

Such tilting-suppression members 360 are provided to prevent the steering-assembly 100 and the tilting-capable assembly 200 from being tilted too easily or sensitively to either one of the left and right sides. In other words, the tilting-suppression members 360 may be configured to allow the tilting-capable assembly 200 to be tilted only by tilting the steering-assembly 100 using a force exceeding a predetermined force. In one example, each of the tilting-suppression members 360 may include a tension spring or the like.

Further, according to the present disclosure, a stopper (not shown) may be provided to prevent excessive elevation of the vertically-movable elongate assembly 400. According to one example, the stopper may be provided near a portion of the rotatable elongate body 240 to which one end (front end) of each of the left and right vertically-movable elongate bars 411 and 412 is coupled.

Hereinafter, the tilting operation of the tilting-capable three-wheeled boarding vehicle 10 according to the embodiment of the present disclosure will be described in more detail.

When the boarding vehicle 10 according to the present disclosure is operated at a low speed or a straight line, and the foot of the occupant is released from any one vertically-movable elongate bar 411 or 412, or the two vertically-movable elongate bars 411 and 412 are stepped on, the tilting-capable assembly 200 is not tilted. This is true even when the occupant shifts their weight toward one side. Therefore, the occupant or the user need not balance the vehicle separately. Therefore, the user can operate the boarding vehicle 10 stably.

On the other hand, when the present boarding vehicle 10 travels a curve road or a corner, the vehicle body may be inclined to the opposite side to the side toward which the centrifugal force acts, that is, to an inward side.

Referring to FIG. 3, when the steering-assembly 100 is tilted in the direction of an arrow D1, the tilting-capable assembly 200 is also inclined in the same direction of an arrow D2. Further, the left and right vertically-movable elongate bars 411 and 412 coupled to the rotatable elongate body 240 may also be tilted together with the tilting-capable assembly 200.

In this connection, it is natural that the rear end of the vertically-movable elongate bar 411 or 412 on the inclined side descends and the vertically-movable elongate bar 412 or 411 on the opposite side ascends. However, since the rear ends of the left and right vertically-movable elongate bars 411 and 412 are resting on the first support bar 340, the vertically-movable elongate bar 411 or 412 on the inclined side is still on the first support bar 340 and is not further lowered.

On the other hand, the rear end of the vertically-movable elongate bar 412 or 411 on the opposite side is pressed by the weight of the occupant, so that the bar 412 or 411 on the opposite side may not be lifted up and remains on the first support bar 340.

In such a case, the rear end of the vertically-movable elongate bar 411 or 412 on the inclined side slightly moves rearward, and the rear end of the vertically-movable elongate bar 412 or 411 on the opposite side slightly moves forward. Thereby, the tilting-capable assembly 200 may be inclined.

Moreover, according to the present disclosure, even when the user makes a weight shift while the steering-assembly 100, the tilting-capable assembly 200 and the vertically-movable elongate assembly 400 are inclined, the tilting-capable assembly 200, and the vertically-movable elongate assembly 400 may not move. Therefore, in order to return the tilting-capable assembly 200 to its original state, instead of the weight shift of the occupant, the steering-assembly 100 may be returned to the non-tilted and balanced state. In this way, the tilting-capable assembly 200 and the vertically-movable elongate assembly 400 together may be returned to the non-tilted and balanced state.

In this way, the boarding vehicle 10 according to the present disclosure tilts by operating the steering-assembly 100, not by the weight shift of the user. Thereby, a force to tilt the tilting-capable assembly 200 and the non-tilted assembly 300 and the like to one side may not be generated, thereby enabling safer running.

In addition, the tilting-capable three-wheeled boarding vehicle 10 according to the embodiment of the present disclosure may further include the second support bar 250.

The second support bar 250 may be installed on the rotatable elongate body 240 in parallel to the first support bar 340. The second support bar 250 with a smaller length than the first support bar 340 may be provided. In other words, the second support bar 250 may be positioned at a predetermined longitudinal position of the rotatable elongate body 240 below the vertically-movable elongate assembly 400. The second support bar 250 may extend perpendicularly to the rotatable elongate body 240 when seen from above. In one example, the second support bar 250 may be positioned below the left and right vertically-movable elongate bars 411 and 412 and nearby one end (front end) of each of the left and right pedals 421 and 422.

The second support bar 250 may be tilted to one side together with the steering-assembly 100, the tilting-capable assembly 200, and the vertically-movable elongate assembly 400. That is, when the steering-assembly 100 is tilted to one side by the occupant or user, the second support bar 250 may be tilted to one side, together with the tilting-capable assembly 200 and the vertically-movable elongate assembly 400.

During normal bicycle travel, as the occupant grips the horizontal handle, the bicycle does not fall due to inertia force. In the case of a board or bicycle on which the user stands up, it does not fall even when the pedal is stepped on, and it travels while generating left/right directional shake. However, in the case of the ordinary bicycle, when the speed is reduced, the inertia force is reduced, so the bicycle tends to fall.

According to the present disclosure, the tilting of the tilting-capable assembly 200 and the vertically-movable elongate assembly 400 may be achieved without the second support bar 250. In addition, there is no tilting force even when the running speed is reduced or it is stopped, or when the driver does not step on the vertically-movable elongate bar.

As shown in FIG. 5, when the force pressing the pedal 421 or 422 follows the imaginary straight line X direction of the extension of the vertically-movable elongate bar, no tilting force acts. Of course, when the force moves in one direction, a force tending to tilt the vehicle toward the direction of the movement may act correspondingly.

Therefore, the conventional bicycle tends to tilt even when the pedal is lifted up. However, according to the present disclosure, there is no force tending to tilt the vehicle to one side even when the vertically-movable elongate bar rises up. However, when the user steps on the vertically-movable elongate bar, the force to tilt the vehicle may be generated to a certain degree, as it may the case for the board or bicycle on which the user stands up.

However, in accordance with the present disclosure, due to the presence of the second support bar 250, there is no force tending to tilt the vehicle when the vertically-movable elongate bar is depressed.

Generally, when the weight is applied to the elevated pedal, which is much greater than that applied to the pedal on the opposite side, a tilting force acts. However, when riding a general bicycle, it is not preferable to apply a lot of weight because it is not good for the knee health.

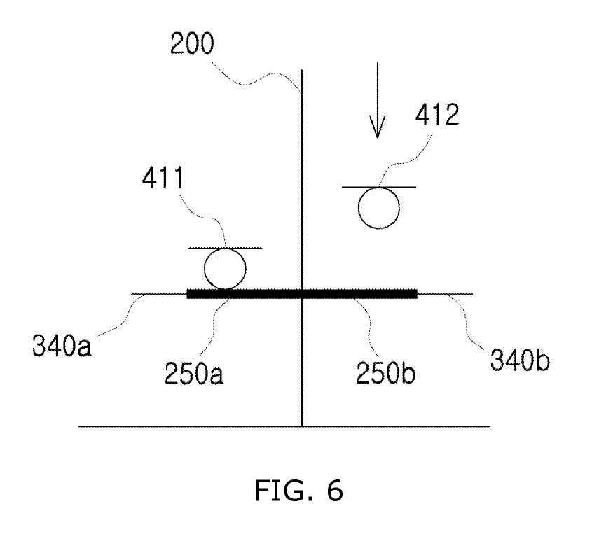

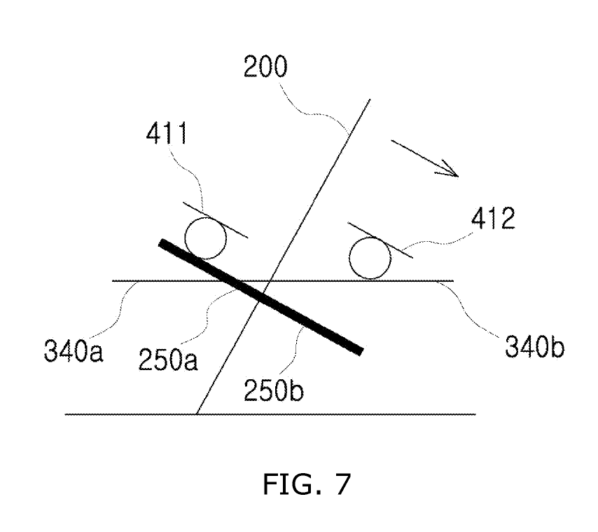

FIGS. 6 and 7 are schematic views for illustrating a tilting operation of a tilting-capable assembly and a vertically-movable elongate assembly with connection to a first support bar and a second support bar, according to an embodiment of the present disclosure.

As shown in FIG. 6 and FIG. 7, for the sake of convenience of illustration, the first support bar 340 is divided into the left and right first support bars 340a and 340b, and the second support bar 250 is divided into the left and right second support bars 250a and 250b respectively.

The first support bar 34o and the second support bar 250 may be provided at the same height, as shown herein. However, one of the first support bar 340 or the second support bar 250 may be positioned at a higher or lower level than the other. The present disclosure is not limited to this. It is sufficient that the first and second support bars 340 and 250 contact the vertically-movable elongate bars 411 and 412 when the user completely depresses the vertically-movable elongate bars 411 and 412.

Referring to FIG. 6, when the first left support bar 340a is in a fixed state, the left vertically-movable elongate bar 411 is depressed, and, thus, the left vertically-movable elongate bar 411 presses the first left support bar 340a. In this connection, the first left support bar 340a is not tilted in the left vertically-movable elongate bar 411 direction.

Because the right vertically-movable elongate bar 412 floats above the right first support bar 340b and is not supported, pressing the right vertically-movable elongate bar 412 enables the tilting-capable assembly 300 to tend to be tilted toward the right vertically-movable elongate bar 412.

However, in a state where the left vertically-movable elongate bar 411 and the first left support bar 340a are in contact with each other, a force tilting the tilting-capable assembly 200 toward the left vertically-movable elongate bar 411 does not work. When the tilting-capable assembly 200 is slightly tilted toward the right vertically-movable elongate bar 412, the second left support bar 250a pushes the left vertically-movable elongate bar 411, and, thus, the left vertically-movable elongate bar 411 floats above the first left support bar 340a. At the same time that the left vertically-movable elongate bar 411 is floated from the first left support bar 340a at a very minute distance, the left vertically-movable elongate bar 411 pushes the second left support bar 250a, and, thus, a force tilting the assembly 200 toward the left vertically-movable elongate bar 411 acts. Therefore, even when the right vertically-movable elongate bar 412 is depressed, the assembly 200 is not tilted toward the right vertically-movable elongate bar 412. That is, the second left support bar 250a and the second right support bar 250b are movement-interrupted by the left vertically-movable elongate bar 411 and the right vertically-movable elongate bar 412 respectively, the assembly 200 is not tilted.

When the right vertically-movable elongate bar 412 is depressed such that the right vertically-movable elongate bar 412 is lowered to reach the first right support bar 340b, the bar 412 does not descend further. At the same time, the right vertically-movable elongate bar 412 also touches the second right support bar 250b.

Of course, when the second right support bar 250b contacts the right vertically-movable elongate bar 412 at an earlier time than the first right support bar 340b, after the tilting-capable assembly 200 is slightly further tilted, the right vertically-movable elongate bar 412 rests on the first right support bar 340b. Conversely, when the first right support bar 340b contacts the right vertically-movable elongate bar 412 at an earlier time than the second right support bar 250b, there is generated a slight gap between the right vertically-movable elongate bar 412 and the second right support bar 250b. At this time, when the opposite vertically-movable elongate bar is depressed, the assembly 220 is inclined to the opposite vertically-movable elongate bar by the gap. Thus, it is preferable that when the vertically-movable elongate bar 412 is completely lowered, there occurs a contact between the first right support bar 340b and the second right support bar 250b.

Moreover, when the user removes the step away from the left vertically-movable elongate bar 411, the left vertically-movable elongate bar 411 rises, and the right bar 412 does not descend any more since the bar 412 is rested on the first right support bar 340b. Thus, there is no force pressing the second right support bar 250b, and, thus, the tilting-capable assembly 200 is not tilted toward the right vertically-movable elongate bar 412.

Further, pressing the elevated left vertically-movable elongate bar 411 forces the tilting-capable assembly 200 to tilt toward the left vertically-movable elongate bar 411. When the assembly 200 is slightly tilted, the second right support bar 250b pushes the right vertically-movable elongate bar 412 up and, at the same time, the right vertically-movable elongate bar 412 is separated from the first right support bar 340b. Thus, a force depressing the right vertically-movable elongate bar 412 depresses the second right support bar 250b. Thus, the tilting-capable assembly 200 is not tilted.

Referring to FIG. 7, when a user holds the horizontal handle 110 and tilts the handle in the direction of the arrow, most of the body weight is loaded on the foot on which the vertically-movable elongate bar 412 rests. Thus, a loading force applied to the left vertically-movable elongate bar 411 may be very small. Thus, although the left vertically-movable elongate bar 411 is separated from the left first support bar 340a, the resistance force against a force tilting the tilting-capable assembly 200 (the resistance force is a tilting the tilting-capable assembly 200 toward the left vertically-movable elongate bar 411) is small. Furthermore, the right vertically-movable elongate bar 412 rises slightly and thus is separated from the second right support bar 250b.

When the assembly 200 returns from the tilted state to the balanced state, the tilting-capable assembly 200 quickly returns to its balanced state (that is, the left vertically-movable elongate bar 411 is placed on the first left support bar 340a) because the large body weight is loaded on the left vertically-movable elongate bar 411. At this time, the right vertically-movable elongate bar 412 descends as much as it ascends at the time of tilting, and, thus, the bar 412 touches the second right support bar 250b.

At this time, the power-transmission (rope) on the right vertically-movable elongate bar 412 side is pulled slightly. However, this is not a problem. This is because when returning the assembly 200 from a tilted state to the balanced state, it is desirable to escape the corner while raising the speed of the vehicle.

As described above, according to the present disclosure, it is possible to prevent the boarding vehicle from tilting to one side when the weight of the occupant shifts to said one side by depressing the pedal on said one side.

Further, according to the present disclosure, when both pedals are stepped on both feet respectively, the vehicle may be driven in a stable posture without being tilted to one side. In addition, when the vehicle travels on a corner or curved path, the user may tilt the steering-assembly to tilt the tilting-capable assembly, thereby enabling safe cornering.

The description above is merely illustrative of the idea of the present disclosure, and various changes and modifications may be made by those skilled in the art without departing from the essential characteristics of the present disclosure.

Therefore, the embodiments disclosed in the present disclosure are intended to illustrate the present disclosure rather than to limit the scope of the present disclosure. The scope and sprit of the present disclosure is not limited by these embodiments.

The scope of protection of the present disclosure should be construed according to the following claims, and all technical features within the scope of equivalents thereof should be construed as being included in the scope of the present disclosure.

1. A tilting-capable three-wheeled boarding vehicle comprising:
a steering-assembly configured to enable steering and tilting of the vehicle;
a tilting-capable assembly including one driving-wheel located below the steering-assembly, and a rotatable elongate body extending from the steering-assembly toward driven-wheels;
a non-tilted assembly including a non-rotatable elongate body, the two driven wheels, a shaft connecting the two driven wheels to each other, and a first support bar extending perpendicularly to the non-rotatable elongate body, wherein the rotatable elongate body is rotatably coupled to the non-rotatable elongate body, wherein the first support bar and the shaft are arranged in parallel spaced apart from each other;
a vertically-movable elongate assembly pivotally coupled, at one end thereof, to the rotatable elongate body and contacting, at the other end thereof, the first support bar during downward movement thereof, wherein the vertically-movable elongate assembly is configured to vertically move by pedaling forces from a user, wherein the vertically-movable elongate assembly is divided into left and right vertically-movable elongate assemblies; and
a power-transmission operatively coupled to the vertically-movable elongate assembly and configured to transmit the pedaling forces from the vertically-movable elongate assembly to the driving-wheel,
wherein when the steering assembly is tilted to one side, the non-tilted assembly is configured not to be tilted, but the tilting-capable assembly and the vertically-movable elongate assembly are configured to be together tilted to said one side.

2. The vehicle of claim 1, wherein the tilting-capable assembly further comprises a second support bar, wherein the second support bar extends perpendicularly to the rotatable elongate body and is disposed on the rotatable elongate body and is spaced apart from and parallel to the first support bar, wherein the second support bar is configured to be tilted to said one side together with the steering assembly, the tilting-capable assembly, and the vertically-movable elongate assembly.

3. The vehicle of claim 1, wherein the left and right vertically-movable elongate assemblies include respectively:
left and right vertically-movable elongate bars, wherein one end of each of the left and right vertically-movable elongate bars is pivotally coupled to the rotatable elongate body so as to be movable up and down, wherein the left and right vertically-movable elongate bars extend such that a distance therebetween gradually increases toward the other end thereof; and
left and right pedals provided on the other ends of the left vertically-movable elongate bar and the right vertically-movable elongate bar respectively,
wherein the left and right pedals are placed on and extend along left and right extension straight lines of the left and right vertically-movable elongate bars respectively, wherein the left and right extension straight lines extend respectively between the rear ends of the left and right vertically-movable elongate bars and left and right points from a central point of one end of the rotatable elongate body to which said one ends of the left and right vertically-movable elongate bars are coupled respectively.

4. The vehicle of claim 1, wherein when the tilting-capable assembly and the vertically-movable elongate assembly are tilted to one side, the other end of the vertically-movable elongate assembly on the tilted side remains on the first support bar while the other end of the vertically-movable elongate assembly on the opposite side to the tilted side is held in contact with the first support bar due to a body weight of the rider being applied to the vertically-movable elongate assembly on the opposite side.

5. The vehicle of claim 1, wherein when the tilting-capable three-wheeled boarding vehicle runs along a straight line or stops, and a force due to a body weight of the occupant is concentrated on either the left or right vertically-movable elongate assemblies, the steering-assembly and the tilting-capable assembly are not tilted.

6. The vehicle of claim 1, further comprising a rotatable tube provided rotatably around a portion of the first support bar on which the other end of the vertically-movable elongate assembly is placed, wherein the rotatable tube is configured to facilitate back and forth movement of the other end of the vertically-movable elongate assembly during the tilting-capable assembly is tilted.

7. The vehicle of claim 1, further comprising left and right tilting-suppression elongate members, each member having one end fixed to the other end of the rotatable elongate body and the other end fixed to each of both ends of the first support bar, wherein each of the tilting-suppression members is configured to prevent the steering-assembly and the tilting-capable assembly from being tilted to either one of left and right sides.

8. The vehicle of claim 2, wherein the left and right vertically-movable elongate assemblies include respectively:
left and right vertically-movable elongate bars, wherein one end of each of the left and right vertically-movable elongate bars is pivotally coupled to the rotatable elongate body so as to be movable up and down, wherein the left and right vertically-movable elongate bars extend such that a distance therebetween gradually increases toward the other end thereof; and
left and right pedals provided on the other ends of the left vertically-movable elongate bar and the right vertically-movable elongate bar respectively,
wherein the left and right pedals are placed on and extend along left and right extension straight lines of the left and right vertically-movable elongate bars respectively, wherein the left and right extension straight lines extend respectively between the rear ends of the left and right vertically-movable elongate bars and left and right points from a central point of one end of the rotatable elongate body to which said one ends of the left and right vertically-movable elongate bars are coupled respectively.

9. The vehicle of claim 2, wherein when the tilting-capable three-wheeled boarding vehicle runs along a straight line or stops, and a force due to a body weight of the occupant is concentrated on either the left or right vertically-movable elongate assemblies, the steering-assembly and the tilting-capable assembly are not tilted.

10. The vehicle of claim 2, further comprising a rotatable tube provided rotatably around a portion of the first support bar on which the other end of the vertically-movable elongate assembly is placed, wherein the rotatable tube is configured to facilitate back and forth movement of the other end of the vertically-movable elongate assembly during the tilting-capable assembly is tilted.

11. The vehicle of claim 2, further comprising left and right tilting-suppression elongate members, each member having one end fixed to the other end of the rotatable elongate body and the other end fixed to each of both ends of the first support bar, wherein each of the tilting-suppression members is configured to prevent the steering-assembly and the tilting-capable assembly from being tilted to either one of left and right sides.
